(19) United States
(12) Patent Application Publication
(10) Pub. No.: US 2025/0292559 A1
(43) Pub. Date: Sep. 18, 2025

(54) METHOD AND APPARATUS FOR IMPROVING EFFICIENCY OF REAL TIME NEURAL NETWORKS FOR IMAGE PROCESSING USING LEARNABLE KERNEL CLASSIFICATION

(71) Applicant: Samsung Electronics Co., Ltd., Gyeonggi-do (KR)

(72) Inventors: Collin ALLEN, San Francisco, CA (US); Rishabh MEHTA, San Jose, CA (US); Pavan LANKA, Danville, CA (US); Michael PHILLIP, Austin, TX (US)

(21) Appl. No.: 18/986,423

(22) Filed: Dec. 18, 2024

Related U.S. Application Data
(60) Provisional application No. 63/565,785, filed on Mar. 15, 2024.

(51) Int. Cl. G06V 10/82; G06V 10/764; G06V 10/94

(52) U.S. Cl. CPC G06V 10/82; G06V 10/764; G06V 10/95

(57) ABSTRACT

A system and a method are disclosed for generating an output image using a learnable kernel classification network. The method including applying a neural network to an input image to output one or more coordinates of kernels stored in a grid; identifying one or more kernels stored in the grid of kernels corresponding to the one or more coordinates; and applying the one or more kernels to one or more regions of the input image to generate the output image.

### CROSS-REFERENCE TO RELATED APPLICATION

This application claims the priority benefit under 35 U.S.C. § 119(e) of U.S. Provisional Application No. 63/565,785, filed on Mar. 15, 2024, the disclosure of which is incorporated by reference in its entirety as if fully set forth herein.

### TECHNICAL FIELD

The disclosure generally relates to real-time image processing using neural networks. More particularly, the subject matter disclosed herein relates to improvements to the efficiency and effectiveness of dense prediction neural networks in constrained computing environments, such as mobile devices.

### SUMMARY

In the rapidly advancing field of computer graphics, neural networks have become a fundamental technology for performing complex image processing tasks directly within a real-time graphics pipeline. These tasks include but are not limited to, super resolution and super sampling, which significantly enhance image quality or reduce the computational demands of rendering pipelines. However, the implementation of such neural network approaches in mobile devices may be hindered by their significant demands for compute resources, memory, and power.

To mitigate these issues, previous solutions have utilized kernel-predicting convolutional networks that dynamically create filters or kernels for processing each pixel of an image. While these methods may have improved the capabilities of real-time graphics rendering, they remain computationally intensive and memory-demanding, particularly when scaled to mobile platforms.

One issue with the above approach is the high computational overhead involved in generating a unique kernel for each pixel and the substantial memory bandwidth required for handling the large volumes of data produced during this process. These challenges limit the practical deployment of advanced neural network-based image processing technologies in power and memory-constrained devices.

To overcome these issues, systems and methods are described herein for utilizing a learnable kernel classification system wherein a neural network is trained not only to perform image transformations but also to select and apply a set of pre-learned kernels stored in memory. This approach shifts the computational burden from generating kernels in real-time (a relatively demanding memory and processing procedure) to classifying and retrieving the appropriate kernels for given image regions (a less demanding memory and processing procedure), thereby reducing the memory bandwidth and computational resources required during inference.

The above approaches improve on previous methods because they offer a significant reduction in the memory and compute requirements of the final network layer, thereby enhancing the feasibility of deploying advanced image processing techniques in resource-constrained environments. Additionally, this method allows for the neural network to maintain a lower capacity while achieving similar or improved transformational capabilities, facilitating more efficient real-time image processing that can adapt to various hardware limitations.

In an embodiment, a method for generating an output image using learnable kernel classification network comprises applying a neural network to an input image to output one or more coordinates of kernels stored in a grid; identifying one or more kernels stored in the grid of kernels corresponding to the one or more coordinates; and applying the one or more kernels to one or more regions of the input image to generate the output image.

In an embodiment, a system for generating an output image using learnable kernel classification network comprises a non-transitory computer readable memory and a processor. The processor is, upon executing instructions stored in the non-transitory computer readable memory, configured to apply a neural network to an input image to output one or more coordinates of kernels stored in a grid; identify one or more kernels stored in the grid of kernels corresponding to the one or more coordinates; and apply the one or more kernels to one or more regions of the input image to generate the output image.

### BRIEF DESCRIPTION OF THE DRAWING

In the following section, the aspects of the subject matter disclosed herein will be described with reference to exemplary embodiments illustrated in the figures, in which:

FIG. 1 illustrates a standard direct prediction method, according to an embodiment;

FIG. 2 illustrates a standard kernel prediction method, according to an embodiment;

FIG. 3 illustrates a learnable kernel classification method, according to an embodiment;

FIG. 4 illustrates an example for generating a single output pixel for a learnable kernel classification method, according to an embodiment;

FIG. 5 is a flowchart illustrating a learnable kernel classification method, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The present application addresses the challenges associated with conventional neural network approaches for real-time processing, specifically in environments constrained by limited compute, memory, and power resources such as mobile devices. Traditional kernel prediction networks, while effective in various scenarios, are not optimized for real-time applications due to their extensive computational requirements and memory usage. These networks typically output a large matrix for each pixel, corresponding to the weights of a kernel, which not only increases the computational load but also causes memory bandwidth constraints.

Recognizing the inefficiencies inherent in predicting individual kernels for each pixel, this application introduces a transformative approach to dense prediction tasks. Rather than generating a unique kernel for every pixel, the proposed neural network architecture predicts which kernel from a predetermined, limited set to apply to each pixel. This is achieved by outputting a set of coordinates for each pixel, which map to a specific kernel stored in memory (e.g., in a kernel grid). By reducing the dimensionality of the output from a potentially large number of individual kernel weights per pixel to just a limited number of coordinates per pixel (e.g., two in an x,y format), the present application significantly reduces the required computational power and memory bandwidth.

“Neural network” as used herein may refer to a computing system that is capable of performing tasks related to pattern recognition, data classification, and decision-making based on the input it receives. Some examples of “neural network” are convolutional neural networks (CNNs), recurrent neural networks (RNNs), and deep neural networks (DNNs).

“Input image” as used herein may refer to any digital representation of visual information that is provided to a system for processing. This may include photographs, videos, and other forms of pixel-based data. Some examples of “input image” are digital photos taken with cameras or smartphones, frames from video streams, and scanned documents.

“Coordinates” as used herein may refer to numerical values or a set of values that specify the position of a kernel within a predefined grid or array. These values are typically used to map or locate specific elements or data points in a multidimensional space. Some examples of “coordinates” are (x,y) positions in a two-dimensional grid, or indices in an array.

“Grid of kernels” as used herein may refer to an organized array or matrix of kernels, where each kernel is designed to perform specific image transformations when applied to an image. This grid may facilitate the selection and application of kernels based on coordinates output by a neural network. Some examples of “grid of kernels” are a two-dimensional matrix of image filters each designed for tasks such as edge detection, blurring, sharpening, or color adjustment. In other embodiments, a “grid of kernels” may include three dimensions or more.

“Kernel” as used herein may refer to a matrix used to apply effects or transformations to portions of an image through convolution operations. Kernels may be used to manipulate the pixel values within their area of influence, based on the mathematical function defined within the kernel itself. Some examples of “kernel” are Gaussian blur filters, Sobel edge detection filters, and sharpening filters.

“Output image” as used herein may refer to the final digital image produced by applying selected kernels to an input image according to the learnable kernel classification method. This image may represent the visual result of the transformations applied during the process. Some examples of “output image” are enhanced photographs where specific features are sharpened, noise-reduced night mode images, or stylized versions of the original input images.

The neural network architecture, described herein, includes a feature map prediction method, where the network predicts coordinates for each pixel of an output image. These coordinates are used to reference specific kernels within a predefined set (e.g., a grid of kernels) for each pixel of the output image. There is also a kernel application mechanism for generating kernels based on the predicted coordinates and applying these kernels to the input image to process and transform the image accordingly. Moreover, a joint training procedure may be used to ensure that the network efficiently learns to select the most appropriate kernels for different image regions, adapting dynamically to varied content within the image.

This architecture not only simplifies the network's operations during inference but also allows for a reduction in the size of the neural network needed to achieve high-quality image transformations. Additionally, the method optimizes the balance between compute and memory usage, making it particularly suitable for real-time image processing tasks on mobile devices.

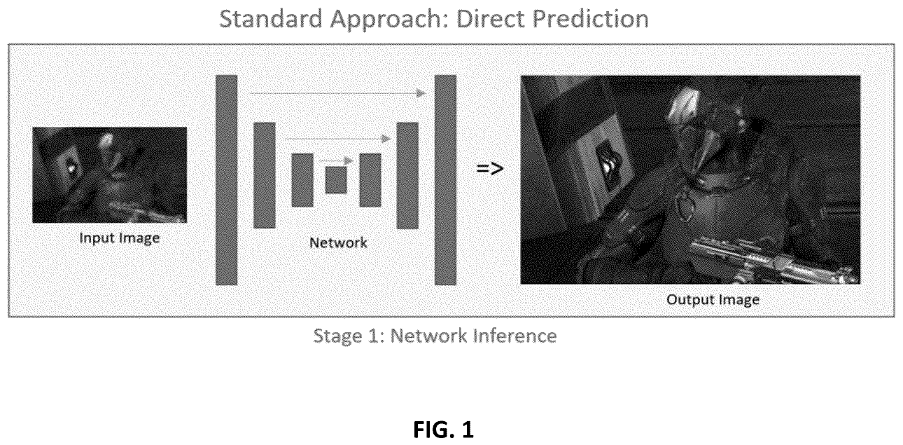

FIG. 1 illustrates a standard direct prediction method, according to an embodiment.

Referring to FIG. 1, the direct prediction approach (or a “standard kernel prediction” approach) typically involves dynamically generating a unique convolutional kernel or filter for each pixel in an output image based on the input data (input image). This method requires the neural network to learn during training how to tailor these kernels to optimize image processing effects such as enhancing detail or reducing noise.

This approach is characterized by high computational demands as it necessitates predicting a complete set of kernel weights for every pixel in the output image, resulting in a substantial volume of data that needs to be processed and stored. The memory requirement is also significant because each pixel's unique kernel must be stored, presenting challenges particularly for devices with limited memory bandwidth or storage capacity, such as mobile devices. Additionally, the high computational and memory demands make implementing this approach in real-time applications on constrained devices impractical.

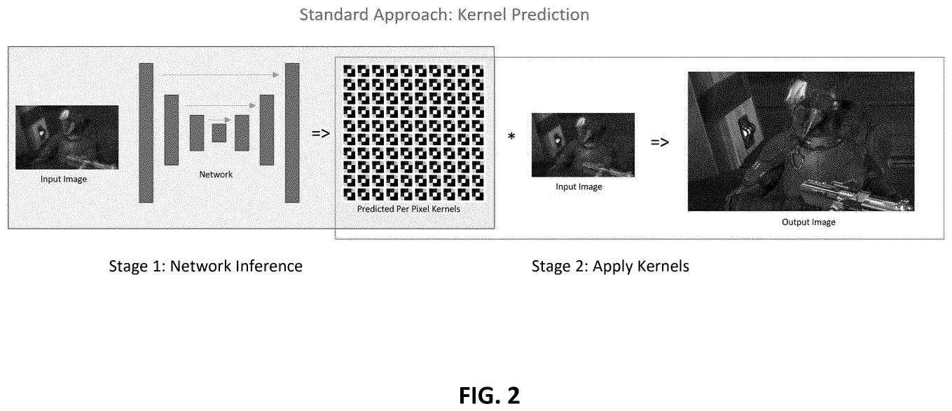

FIG. 2 illustrates a standard kernel prediction method, according to an embodiment.

Referring to FIG. 2, the kernel prediction approach (or a “network task separation” approach) strategically divides the roles and responsibilities within the network to enhance efficiency and effectiveness in image processing. This approach is useful in addressing the limitations of conventional neural network designs by simplifying and optimizing the tasks assigned to the network during the image transformation process.

In this method, the network's responsibility is split into two main functions: first, identifying which pixels in an image should be processed by the same type of transformation (“network inference”), and second, determining the specific transformation, or kernel, to be applied (“apply kernels”). By separating these steps into stages, the network simplifies the computational challenges that typically accompany dense prediction tasks.

The first stage involves the network predicting coordinates or a form of identifiers for groups of pixels. These identifiers are used to determine which pixels share similar characteristics and therefore should undergo the same type of kernel-based transformation. This step reduces the complexity of the network's operation by categorizing pixel groups, thus limiting the range of output the network must handle at any one time.

Following the identification of these pixel groups, the second stage generates one or more kernels for each of the identifiers determined in the first stage. In this approach, the network must both identify what operations to apply to each pixel and create the kernel to perform that operation, which may be computationally intensive.

Nevertheless, the separation of tasks into stages reduces the computational burden during the network's operational phase.

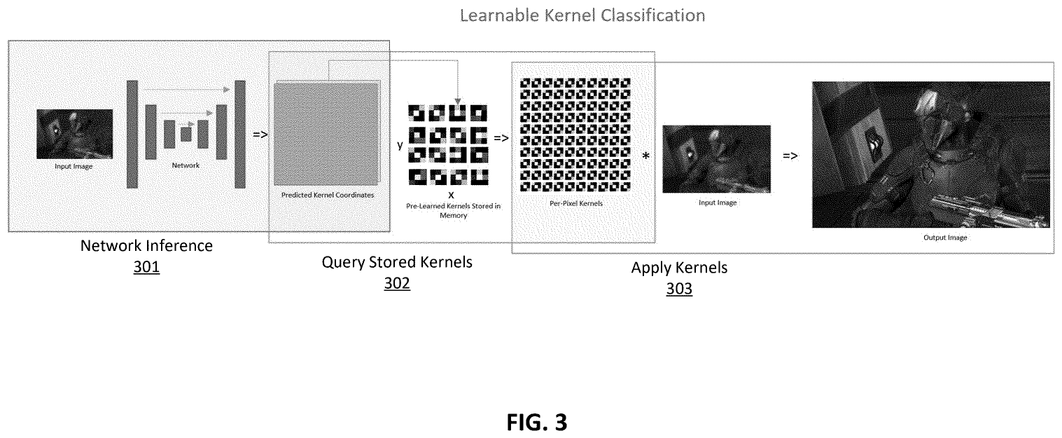

FIG. 3 illustrates a learnable kernel classification method, according to an embodiment.

The learnable kernel classification approach enhances neural network performance for image processing by optimizing the efficiency and flexibility of kernel utilization. This approach addresses the limitations of both the direct prediction (FIG. 1) and kernel prediction (FIG. 2) approaches by creating a balance that leverages the strengths of each.

In this method, the neural network undergoes training to not just perform image transformations directly but to learn a basis set of kernels that can be combined or modified during inference. That is, the network may learn a compact representation (e.g., a two dimensional grid) of an otherwise potentially vast kernel space.

During the training phase, the network acquires a set of kernels that may represent a variety of transformations needed for the tasks at hand. These kernels are not necessarily an exhaustive list of all possible kernels but are instead a selected subset that can be combined to form new kernels as needed. The network may learn to associate specific features in the input data (e.g., input image data) with particular kernel coordinates. This may be achieved through a supervised learning approach, where the network is trained against known outcomes to minimize error in coordinate prediction. Techniques such as gradient descent and backpropagation may be employed to adjust weights within the network, enhancing its ability to predict accurate kernel coordinates.

At runtime, the network uses the input data (e.g., input image data) to predict which kernels from this learned basis should be combined and how they should be combined to produce the optimal output. This might involve predicting coordinates or factors that specify how to blend these basis kernels to form the final kernel applied to each pixel or region of the output image.

Referring to FIG. 3, three stages (e.g., steps) of the learnable kernel classification method are shown. More or less stages may be included. Moreover, each stage may encompass more than a single stage (or step) in terms of the number of functions being performed.

Step 301, network inference, involves the input image being processed by the neural network, which is configured to analyze the image and predict coordinates for kernel retrieval. Each of the pixels in the input image are simultaneously processed (e.g., processed in parallel). The simultaneous processing of the pixels is necessary to ascertain certain features that are not otherwise able to be detected (e.g., features that are not able to be detected in the case of serial processing of pixels). For example, simultaneous processing of the pixels in the input image enables kernels to be trained based on a spatial relationship among pixels in the input image. Unlike standard methods that output direct transformation kernels, this learnable kernel classification network predicts indices (e.g., two dimensional coordinate values) within a latent kernel space, shown as “Predicted Kernel Coordinates” in FIG. 3. Each of the indices may have a height and width that is the same as the height and width of the output image.

The generated indices are designed to map to pre-learned kernels (which may be stored in a grid), which represent a basis set that encapsulates the transformations required for the image processing tasks. In the present example, only two indices are generated per pixel of the input image. On the other hand, in other kernel prediction approaches, more pieces of information are generated for each pixel. For example, in other kernel prediction approaches, if a 5×5 filter is applied to each pixel of the input image, then generating per-pixel kernels may include generating 25 pieces of information per pixel of the output image to account for the 5×5 filter. In other words, in other kernel prediction approaches the network must generate an entire kernel for each pixel of the output image.

Although other kernel prediction approaches and the solution provided in the present disclosure may both be capable of generating a map of predicted kernels for each pixel of the output image (this map of predicted kernels corresponding to “Predicted Per Pixel Kernels” in FIG. 2 and “Per-Pixel Kernels” in FIG. 3), the present solution introduced in this disclosure is able to do so more efficiently since fewer pieces of information (indices) are generated for each pixel of the input image. As discussed below, the indices are used to query a set of pre-learned kernels stored in memory to generate the set of “Per-Pixel Kernels” for the output image.

In step 302, query stored kernels, the network queries a stored set of kernels based on the generated indices. As explained above, these indices may correspond to coordinate values of a pre-learned stored set of kernels (shown as “Pre-Learned Kernels Stored in Memory” in FIG. 3). The kernels queried from the pre-learned stored set of kernels may form a basis from which the final kernels (the “Per-Pixel Kernels” shown in FIG. 3) are constructed. For example, one kernel for each pixel of the output image may be retrieved from the pre-learned stored set of kernels based on the coordinate values of the generated indices to synthesize the final set of (“Per-Pixel Kernels” in FIG. 3) kernels needed for the specific image transformation tasks. Therefore, the pre-learned stored set of kernels may act as a kernel database from which each kernel in the final set of kernels is selected from. This approach may reduce the memory load and enhance the flexibility of kernel use.

In step 303, apply kernels, the selected kernels may be applied to the original input image. This transforms the input image into the output image by applying the transformations encoded within the kernels.

Accordingly, the learnable kernel classification approach offers several significant improvements over standard approaches. By learning a basis set of kernels rather than generating a unique kernel for every pixel or using a static one-size-fits-all kernel, this method may reduce the computational overhead and memory usage during inference while maintaining a high quality image enhancement. The network does not need to generate large volumes of kernel data for each pixel; instead, it selects and combines a small number of basis kernels, which may be computationally less intensive.

Furthermore, the network can adapt the combination of basis kernels based on the specific content and characteristics of the input image. This adaptability may allow for customized transformations that can better address specific features or anomalies in the image. Additionally, the quality of the image processing can be enhanced because the network may use a set of optimized kernels that are specifically trained for the task. The ability to combine these kernels in various ways may allow the network to finely tune the output, potentially leading to higher quality results than those achievable with a single kernel.

Moreover, this learnable kernel classification approach scales effectively to different types of hardware and different image processing requirements. Since the computational load may be reduced, it can be deployed on devices with varying capabilities, from high-end servers to mobile devices, without a significant loss in performance.

Additionally, the learnable kernel classification approach discretizes the transformation space. This approach simplifies the network's tasks by reducing it to selecting among discrete options, rather than continuously varying outputs.

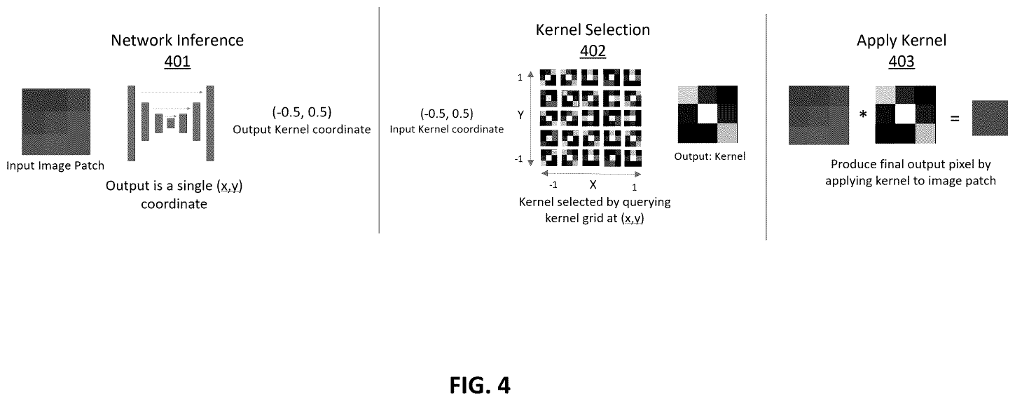

FIG. 4 illustrates an example for generating a single output pixel for a learnable kernel classification method, according to an embodiment.

Referring to FIG. 4, an example of the learnable kernel classification approach is shown, broken down into three sequential steps that describe the process from input image handling to the application of a transformation kernel to produce an output pixel. This example details the use of a single image patch to illustrate how each component within the framework contributes to the overall image processing task.

In step 401, network inference, a patch from the input image is processed by a neural network. The network analyzes the characteristics of this image patch and outputs a single coordinate (x,y). This coordinate corresponds to a location within a pre-defined kernel grid from which a specific kernel will be selected. The pre-defined kernel grid includes kernels corresponding to each coordinate in the grid. The example provided shows an output kernel coordinate of (0.5, 0.5), which represents the neural network's prediction based on the input image patch's data.

Following the network inference, in step 402, kernel selection, the single coordinate is used to query a kernel from the stored kernel grid. Each kernel in this grid has been pre-learned and optimized during the training phase of the neural network to perform specific types of image transformations. The coordinate (0.5, 0.5) corresponds to a specific kernel in the grid, which is then selected for use at the location of the final output pixel.

In step 403, apply kernel, the selected kernel is applied to the original input image patch. The application of the kernel is typically achieved through a convolution operation, where the kernel is applied over the image patch to produce a transformed output. In this example, the result of applying the kernel is a single output pixel. Thus, the kernel modifies the original image patch to produce the final output pixel. This step demonstrates the transformation capability of the selected kernel, influenced by the neural network's initial prediction using the kernel grid, which has been generated through training and stored for quick access to kernels without having to generate new kernels at each pass.

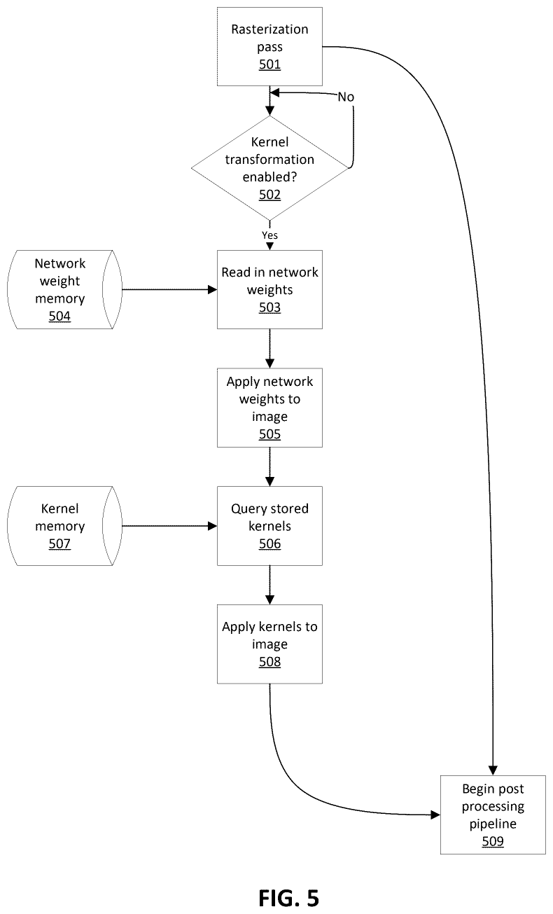

FIG. 5 is a flowchart illustrating a learnable kernel classification method, according to an embodiment.

Referring to FIG. 5, the learnable kernel classification method may enhance the efficiency of image processing applications such as super resolution, ray tracing denoising, frame interpolation, and/or temporal anti-aliasing (TAA). For example, a graphics processing unit (GPU) may initially render images at a relatively lower resolution, such as 540 progressive scan (p), and the network may subsequently upscale the images to a relatively higher resolution, such as 1080p using the learnable kernel classification method provided herein. Although a number of steps are shown, the learnable kernel classification method may include more or less steps shown in FIG. 5. Moreover, one or more of the steps may be combined, performed simultaneously, or performed in a different order than what is shown.

In step 501, the process begins with a rasterization pass where the input image is prepared for processing. This step may involve converting the input image into a format that the neural network can efficiently handle, and organizing the image data into pixels or grid patterns that are suitable for subsequent analysis and digital image processing. For example, the input image may be a relatively low resolution image, such as 540p.

In step 502, the process identifies whether kernel transformation is enabled. If kernel transformation is enabled, the process proceeds to step 503. Otherwise, the process continues to check for whether kernel transformation is enabled.

In step 503, network weights are read in from network weight memory 504. Network weights reference the utilization of the training data of the network. The training data may represent the result of the network learning to predict kernel coordinates that are optimally suited for each pixel of the input image, based on the transformation required (e.g., upscaling in the case of super resolution). These weights enable the network to accurately predict the kernel coordinates based on the input image data. The network weight memory 504 may be stored locally on a user device, or remotely on a remote server or network device, and the processing of the network weights in step 504 may be performed locally on the user device, or remotely on a device other than the local user device.

In step 505, the network weights are applied to the input image. Here, the network analyzes the input image data to output one or more coordinates corresponding to the most appropriate kernels in a stored grid for image transformation (corresponding to “Pre-Learned Kernels Stored in Memory” in FIG. 3). The term “most appropriate” may refer to the selection of kernels that are best suited for the specific transformations required by segments or features within the image. This appropriateness can be determined by the network's ability to map input data characteristics to the optimal kernel coordinates. For instance, if the neural network outputs coordinate 0.51, 0.51, and the nearest coordinate in the kernel grid is 0.5, 0.5, the network may round to the nearest coordinate to identify the most appropriate kernel. This rounding may ensure that each pixel or region of the image is processed using the kernel that most closely matches the required image transformation, which optimizes the accuracy and efficiency of the image processing task.

Since, the kernel coordinates are provided in a grid-like manner, each of the pixels in the input image data may be processed together (e.g., at the same time) to generate, train and/or store an “image” of kernel coordinates (instead of generating individual kernels for each red, blue, green (RGB) output pixel), thereby improving the speed and efficiency of image processing.

In step 506, one or more stored kernels are identified (queried) from kernel memory 507, and the process retrieves one or more specific kernels from the stored set in memory, selected based on the coordinates output by the neural network. The kernel memory 507 may be a local memory stored on a terminal device or an electronic device. The kernels may be stored in a structured grid, indexed for efficient retrieval based on the coordinates output by the neural network. This storage method supports the high-speed access required for real-time image processing applications since kernels may be quickly (or simultaneously) retrieved.

The kernel retrieval process is targeted to fetch the one or more kernels that are best suited to handle the transformations needed for the given input image data. For example, a custom shader may process the coordinate image of the kernels alongside the original input image. This shader may apply the corresponding kernels to each pixel or a neighborhood of pixels in the input image through a modified convolution process.

The stored kernels are the pre-trained kernels that have been stored in memory 507, ready to be accessed based on the neural network's predictions. As discussed above, the kernels may be stored in a grid, and the coordinates may correspond to one or more cells in the grid, thereby identifying one or more kernels. Furthermore, the output coordinates may identify a cell using a predefined range, interpolation, or by rounding.

In step 508, the selected one or more kernels are applied to the input image. This involves using the one or more kernels to execute the transformations on the input image, altering its features or details as necessary to produce the desired output. The selected one or more kernels may be combined with a portion of the input image to generate a single pixel of the output image.

Following the application of one or more selected kernels to generate a single pixel of the output image as described in step 508, the process may be repeated for each pixel of the output image to generate the output image.

Accordingly, the method is not isolated to just one pixel. Instead, this method can be iteratively executed across all pixels of the input image (or across all pixels of multiple input images, such as a video) to systematically produce a comprehensive and complete output image. Each pixel may be processed in sequence or in parallel, depending on the computational architecture, to ensure that the entire image undergoes the intended transformation. Each processed image, whether stored for later use or displayed immediately, benefits from the precision and adaptability of this method, due to its utility across a broad spectrum of imaging or other computationally demanding technologies.

In step 509, a post processing pipeline is initiated. For example, after the kernel application in step 508, there may be additional post-processing required to finalize the image output. This last step could include further adjustments or enhancements to ensure that the final output adheres to the desired quality and specifications.

Accordingly, this method may be applied to enhance image resolution, improve visual clarity, or adapt images for different display technologies or processing purposes. For instance, in scenarios where images from surveillance cameras are processed, this method can be used to enhance detail that helps in identifying objects or individuals more clearly. In medical imaging, the method could enhance details to aid in diagnostics. The resulting images can either be stored for archival and further analysis or displayed immediately for real-time applications such as video streaming or in medical diagnostics displays. In another instance, the method may be applied to enhance the quality of images or videos rendered in video games, which may require computationally intensive processing on user devices. As explained above, the method described herein reduces the computational load by using learnable kernel classification.

Although the learnable kernel classification method illustrated in FIG. 5 has been discussed in the context of image processing, which may be implemented by a GPU, the learnable kernel classification method is adaptable and not restricted to GPU implementations alone. This method involves designing a neural network that uses input data, such as images. Also, the method may be extended to other data types, to generate indices. These indices may correspond to coordinates used to query filters, kernels, or other information types for processing the input data.

The flexibility of learnable kernel classification method enables it to be implemented across a variety of hardware platforms beyond GPUs. For instance, it can be effectively deployed on specialized hardware accelerators, field-programmable gate arrays (FPGAs), or even general-purpose processors, depending on the specific requirements and constraints of the application. This adaptability extends the utility of the learnable kernel classification method to various data types beyond images and videos, enhancing processing efficiency in diverse applications such as audio processing, sensor data interpretation, or complex scientific computations. Incorporating the learnable kernel classification method in different hardware environments and with various data types underscores its broad applicability and potential to significantly improve computational efficiency across multiple domains.

The input images for this method may come from many different sources, tailored to suit the needs of specific applications. For instance, in the realm of medical imaging, the inputs could be digital scans from magnetic resonance imaging (MRI) or computed axial tomography (CAT or CT) machines. In consumer electronics, the images might be captured from digital cameras or smartphones (electronic devices), and for applications such as video streaming or gaming, the images could be frames rendered by computer graphics systems (e.g., GPUs or other systems such as CPUs or network servers). In video upscaling, for example, the method can be used to improve the resolution of video frames, enhancing the viewer's experience on higher-resolution displays.

Once the images are processed, they can be utilized in different ways depending on an application's specific requirements. In medical applications, for instance, enhanced images might be stored in patient records for future reference. In the context of digital media production, improved frames could be stored as part of a digital media library. In consumer electronics, particularly in devices like smartphones (e.g., electronic devices or user equipment) and/or digital displays, the enhanced images can be displayed immediately to enhance user experience. In professional settings such as video production or graphic design, the output images might undergo further processing steps, which may be integral into larger digital workflows for additional enhancements or editing.

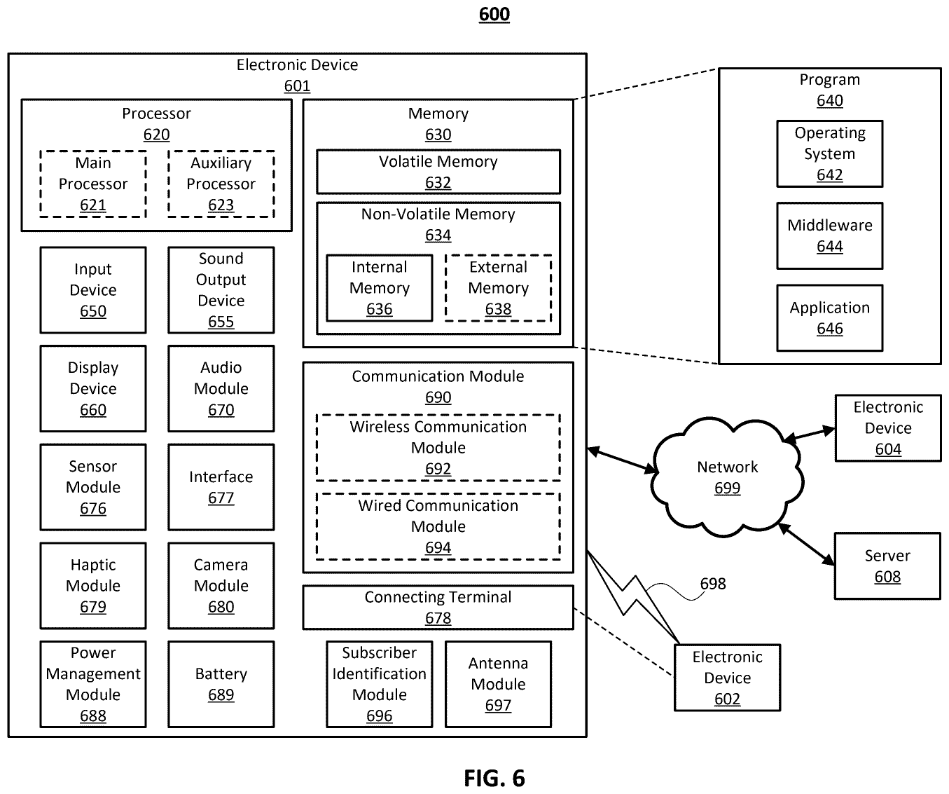

FIG. 6 is a block diagram of an electronic device in a network environment, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single IC. For example, the sensor module 676 (e.g., a fingerprint sensor, an iris sensor, or an illuminance sensor) may be embedded in the display device 660 (e.g., a display).

Moreover, FIG. 6 illustrates a hardware setup for implementing the learnable kernel classification method described in FIG. 5 and other portions of the present Application. The electronic device 601 may be equipped with an array of components that facilitate the execution of advanced computational tasks, including image processing using the learnable kernel classification method.

The communication connectivity of electronic device 601 enables electronic device 601 to potentially offload computational tasks or access additional computational resources and data from other devices or servers, enhancing its processing capabilities for complex tasks such as image processing.

The processor 620 may execute instructions for applying the neural network to input images, outputting coordinates, and managing the operations of querying and applying kernels stored within the device. The memory 630 may store the grid of kernels necessary for the method, along with the neural network's configurations and any temporary data required during image processing.

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple compact disks (CDs), disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for generating an output image using a learnable kernel classification network, comprising:
applying a neural network to an input image to output one or more coordinates of kernels stored in a grid;
identifying one or more kernels stored in the grid of kernels corresponding to the one or more coordinates; and
applying the one or more kernels to one or more regions of the input image to generate the output image.

2. The method of claim 1, further comprising:
training the grid of kernels while training the kernel classification network.

3. The method of claim 1, further comprising:
training the grid of kernels based on a representative dataset.

4. The method of claim 1, wherein the output coordinates identify one cell in the grid of kernels.

5. The method of claim 4, wherein the one cell in the grid of kernels is identified by the output coordinates using a predefined range, interpolation, or by rounding.

6. The method of claim 1, wherein each cell in the grid of kernels corresponds to an individual kernel.

7. The method of claim 1, wherein identifying the one or more kernels further comprises combining multiple kernels to generate a pixel of the output image.

8. The method of claim 1, further comprising performing a bilinear interpolation to sample the grid of kernels based on the output coordinates.

9. The method of claim 1, wherein applying the one or more kernels to the input image includes performing a convolution process to generate a pixel of the output image.

10. The method of claim 1, wherein applying the neural network to the input image to output one or more coordinates further comprises outputting coordinates that map to multiple kernels.

11. A system for generating an output image using a learnable kernel classification network, the system comprising:
a non-transitory computer readable memory and a processor, wherein the processor is, upon executing instructions stored in the non-transitory computer readable memory, configured to:
apply a neural network to an input image to output one or more coordinates of kernels stored in a grid;
identify one or more kernels stored in the grid of kernels corresponding to the one or more coordinates; and
applying the one or more kernels to one or more regions of the input image to generate the output image.

12. The system of claim 11, wherein the processor, upon executing the instructions, is further configured to train the grid of kernels while training the kernel classification network.

13. The system of claim 11, wherein the processor, upon executing the instructions, is further configured to train the grid of kernels based on a representative dataset.

14. The system of claim 11, wherein the output coordinates identify one cell in the grid of kernels.

15. The system of claim 14, wherein the processor, upon executing the instructions, is further configured to identify the one cell in the grid of kernels using a predefined range, interpolation, or by rounding.

16. The system of claim 11, wherein each cell in the grid of kernels corresponds to an individual kernel.

17. The system of claim 11, wherein identifying the one or more kernels further comprises combining multiple kernels to generate a pixel of the output image.

18. The system of claim 11, wherein the processor, upon executing the instructions, is further configured to perform a bilinear interpolation to sample the grid of kernels based on the output coordinates.

19. The system of claim 11, wherein applying the one or more kernels to the input image includes performing a convolution process to generate a pixel of the output image.

20. The system of claim 11, wherein applying the neural network to the input image to output one or more coordinates further comprises outputting coordinates that map to multiple kernels.
